(19) United States
(12) Patent Application Publication
(10) Pub. No.: US 2020/0284325 A1
(43) Pub. Date: Sep. 10, 2020

(54) SEALED TENSIONER WITH CARTRIDGE BODY

(71) Applicant: BorgWarner Inc., Auburn Hills, MI (US)

(72) Inventors: Adam C. HUNT, Brooktondale, NY (US); Seongdo HONG, Ithaca, NY (US)

(21) Appl. No.: 16/800,003

(22) Filed: Feb. 25, 2020

Related U.S. Application Data
(60) Provisional application No. 62/814,926, filed on Mar. 7, 2019.

(51) Int. Cl. F16H 7/08

(52) U.S. Cl. CPC F16H 7/08; F16H 2007/0812

(57) ABSTRACT

A sealed tensioner is used in an automotive application to keep a belt or chain under its intended tension as it wears and stretches. The sealed tensioner is hydraulic but lacks an outside oil supply. The sealed tensioner, in an example, includes an outer body having a first bore. A cartridge body is received in the first bore. The cartridge body has a second bore. A piston is carried in the second bore. A check valve is situated between a low pressure reservoir and a high pressure chamber. One or more baffle walls are located at the low pressure reservoir. The baffle wall(s) block an air pocket in the low pressure reservoir from entering the high pressure chamber.

### CROSS-REFERENCE TO RELATED APPLICATIONS

This application claims the benefit of U.S. Patent Application No. 62/814,926 filed on Mar. 7, 2019, the disclosure of which is herein incorporated by reference in its entirety.

### TECHNICAL FIELD

The present application relates generally to tensioners of belt and chain drive configurations in automotive applications and, more particularly, relates to sealed hydraulic tensioners of belt and chain drive configurations in automotive applications that lack an outside oil supply.

### BACKGROUND

Rotations of camshafts and crankshafts of internal combustion engines in automobiles are typically linked together. Belt drive and chain drive configurations are common ways to carry this out. Sprockets on the camshafts and crankshafts are linked by an endless belt in belt drive configurations, and similarly the sprockets are linked by an endless chain in chain drive configurations. Still, other components in automobiles are linked by belt drive and chain drive configurations such as front end accessory drive components.

The belt and chain drive configurations are commonly equipped with tensioners to help keep the belts and chains tight and under the proper tension as they wear and stretch with use. Some tensioners are spring loaded, and some are hydraulically operated. A conventional hydraulically-operated tensioner has an oil supply from an outside source such as the accompanying internal combustion engine. This usually means that the engine and the tensioner have dedicated oil passages communicating with each other. The outside oil supply also works an unwanted parasitic loss on the engine, among other potential drawbacks.

### SUMMARY

In an implementation, a sealed tensioner may include an outer body, a cartridge body, a piston, a check valve, and one or more baffle walls. The outer body has a first bore. The cartridge body is received in the first bore. The cartridge body has a second bore. The piston is carried in the second bore, and is biased to an extended state. The check valve is situated between a low pressure reservoir and a high pressure chamber. The baffle wall(s) are located at the low pressure reservoir. The baffle wall(s) block an air pocket in the low pressure reservoir from entering the high pressure chamber.

In another implementation, a sealed tensioner may include an outer body, a cartridge body, a piston, and one or more baffle walls. The outer body has a bore. The bore has an inner wall. The cartridge body is interfitted in the outer body's bore. The cartridge body has an outer wall. A low pressure reservoir is established in part or more by a confrontation of the bore's inner wall and the cartridge body's outer wall. An air pocket resides in the low pressure reservoir. The piston is carried by the cartridge body. A high pressure chamber is established in part or more by an interior of the piston. The baffle wall(s) extend from the cartridge body and form a seal with the bore's inner wall. The baffle wall(s) are located near an exit of the low pressure reservoir.

In yet another implementation, a sealed tensioner may include an outer body, a cartridge body, a piston, a passage, a check valve, a clearance, and one or more baffle wall(s). The outer body has a first bore. The cartridge body is received in the first bore. The cartridge body has a second bore. A low pressure reservoir is established in part or more by confronting walls of the outer body and cartridge body. An air pocket resides in the low pressure reservoir. The piston is carried in the second bore and is biased to an extended state. The piston has an interior. A high pressure chamber is established in part or more by the piston's interior. The passage is defined in the cartridge body and provides fluid travel between the low pressure reservoir and high pressure chamber. The check valve is located at an entrance to the high pressure chamber. The clearance resides between the cartridge body and piston. The baffle wall(s) extend from the cartridge body and are located downstream of an entrance of the high pressure chamber.

### BRIEF DESCRIPTION OF THE DRAWINGS

FIG. 1 is a perspective view of an embodiment of a sealed tensioner;

FIG. 2 is a sectional view of the sealed tensioner, depicting the sealed tensioner in an extended state;

FIG. 3 is another sectional view of the sealed tensioner, depicting the sealed tensioner in a retracted state;

FIG. 3A is an enlarged view of the sealed tensioner taken at the circle denoted by 3A in FIG. 3;

FIG. 4 is a side view of an embodiment of a cartridge body of the sealed tensioner, showing the cartridge body in an upright orientation according to an intended installation position;

FIG. 5 is a side view of the cartridge body, showing the cartridge body in a tilted orientation; and

FIG. 6 is a side view of the cartridge body, showing the cartridge body in an upside-down orientation.

### DETAILED DESCRIPTION

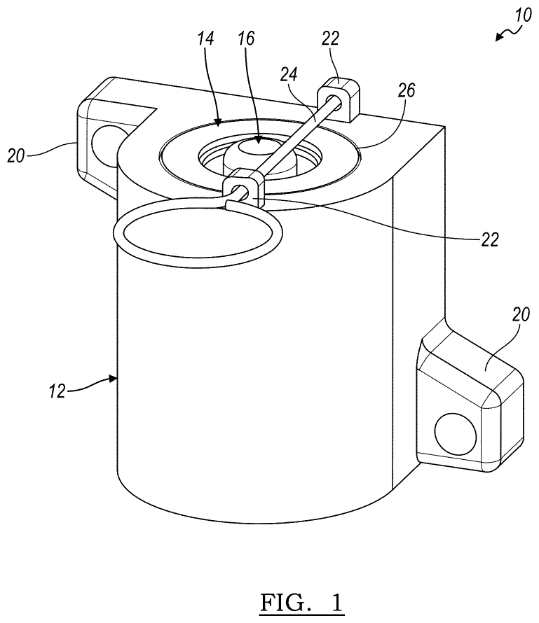

The figures illustrate an embodiment of a sealed tensioner 10 that can be equipped in belt drive and chain drive configurations in automotive applications to help maintain the proper tightness and tension in the associated belts and chains as they wear and stretch with use. The sealed tensioner 10 is hydraulic, and is sealed in the sense that it lacks an outside source of oil supply and hence—unlike some past tensioners—a parasitic loss on the associated larger application is absent with use of the sealed tensioner 10. The outside source of oil supply is commonly from an internal combustion engine in automotive applications. Since the sealed tensioner 10 has no outside oil supply and hence need not be paired with outside oil passages, the sealed tensioner 10 has a greater degree of freedom for its mounting location in the larger application than previously possible. The sealed tensioner 10 can have various designs and constructions in different embodiments, its precise design and construction oftentimes dictated by the particular application in which it will be employed. In the embodiment presented by the figures, and turning now to FIGS. 1-3, the sealed tensioner 10 includes an outer body 12, a cartridge body 14, a piston 16, and a check valve 18. Still, in other embodiments the sealed tensioner 10 can have more, less, and/or different components than those shown in the figures and described below.

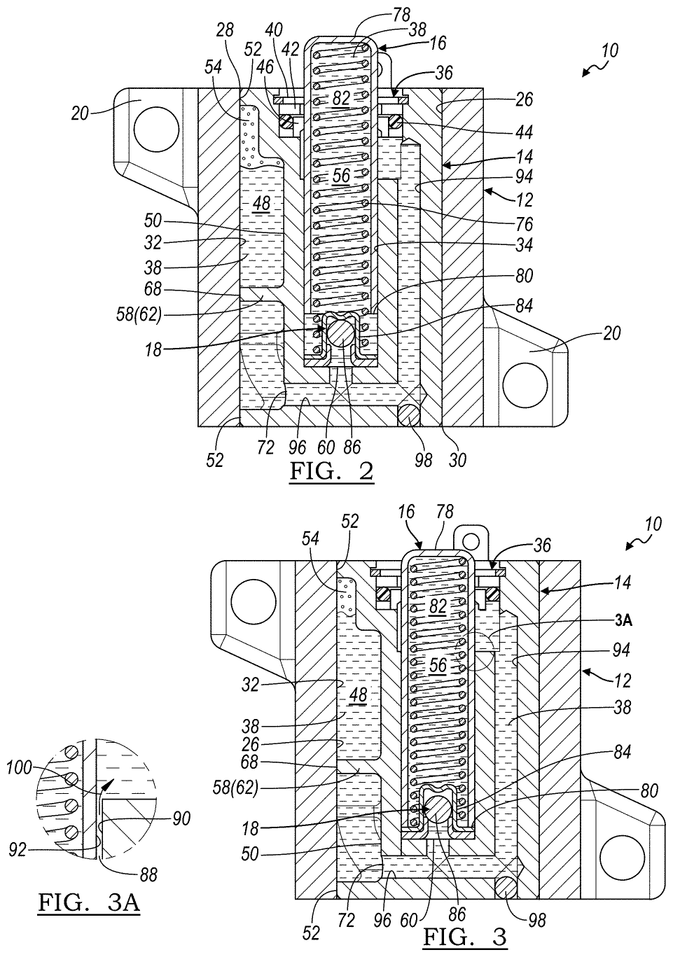

With particular reference to FIG. 1, the outer body 12 serves as the main exterior structure of the sealed tensioner 10. The outer body 12 can be attached to a larger application component like an internal combustion engine in installation, and in this regard has a pair of mounting bosses 20 to effect attachment in this embodiment. A pair of tabs 22 receive a shipping pin 24 that keeps the piston 16 in place while the sealed tensioner 10 is being handled and in transit prior to installation to the larger application component. Once installed, the shipping pin 24 can be removed. Turning now to FIG. 2, the outer body 12 has a bore 26 at its interior. The bore 26 spans through the outer body 12 between a first open end 28 and a second open end 30. The bore 26 has a constant diameter throughout its axial extent. An inner wall 32 of the outer body 12 defines the bore 26. Unlike the cartridge body 14, the outer body 12 lacks passages for oil flow in the sealed tensioner 10. The outer body 12 is a separate and distinct component from the cartridge body 14, and is hence discretely manufactured. The outer body 12 can be made of a metal material such as steel or aluminum. Because the outer body 12 is separately made, it can be more readily designed and constructed according to a particular installation and its mounting needs, while maintaining the design and construction of the cartridge body 14 and other components of the sealed tensioner 10 if so desired.

Turning now to FIGS. 2 and 3, the cartridge body 14 is inserted and received in the bore 26 of the outer body 12. The cartridge body 14 serves to support and assist in establishing other components of the sealed tensioner 10. The cartridge body 14 is fixed in receipt in the bore 26 of the outer body 12 by way of an interfit therebetween. The interfit can be effected by an interference fit, a shrink fit, or some other technique. The interfit can establish certain sealing interfaces between the outer body 12 and cartridge body 14, as described below. The structure of the cartridge body 14 can be composed of a metal material such as steel or aluminum and can be fabricated by a casting process in an example; still, the cartridge body 14 could be composed of a plastic material and by an injection molding process, although in this example a bore for the piston 16 may be made with a metal insert and overmolded with the plastic material. A bore 34 of the cartridge body 14 receives and carries the piston 16. Furthermore, a seal assembly 36 is disposed in the cartridge body 14 and seals fluid 38 within the cartridge body 14 at its location. The fluid 38 can be oil. The seal assembly 36 in this embodiment includes a retaining ring 40, a seal retainer 42, an o-ring 44, and a rod seal 46. The retaining ring 40 keeps the seal retainer 42 in place, while the seal retainer 42 keeps the o-ring 44 and rod seal 46 in place. In other examples of the seal assembly 36, the o-ring 44 and rod seal 46 could be kept in place by a groove in the wall of the bore 34, and the retaining ring 40 and seal retainer 42 could then be absent.

Still referring to FIGS. 2 and 3, in this embodiment a low pressure reservoir 48 is established near an exterior of the cartridge body 14, and is defined by confronting walls and surfaces of the outer body 12 and the cartridge body 14. At a partial circumferential extent of the cartridge body 14, the inner wall 32 of the bore 26 directly confronts and opposes an outer wall 50 of the low pressure reservoir 48 across a spacing therebetween. The low pressure reservoir 48 holds the fluid 38 at a lower pressure in the sealed tensioner 10. When the outer body 12 and cartridge body 14 are interfit together as demonstrated in FIGS. 2 and 3, a seal 52 is formed around a periphery of the low pressure reservoir 48 to keep the fluid 38 therein. The seal 52 can span around the entire periphery of the low pressure reservoir 48. A surface-to-surface interface between the inner wall 32 and outer wall 50 at the periphery forms the seal 52. Although FIGS. 2 and 3 only depict the upper and lower sections of the periphery of the low pressure reservoir 48 and the seal 52 thereat, the periphery has side sections extending between these upper and lower sections. The seal 52 spans along the side sections.

Furthermore, in this embodiment an air pocket 54 resides in the low pressure reservoir 48. The air pocket 54 accommodates and compensates for decreases in volume that arise in the sealed tensioner 10 when the piston 16 moves toward a retracted state. In this way, the air pocket 54 precludes the occurrence of a hydraulic lock condition in the sealed tensioner 10. The volume of a high pressure chamber 56 decreases and the amount of the fluid 38 in the low pressure reservoir 48 correspondingly increases as the piston 16 retracts inward in the cartridge body 14. The fluid 38 is incompressible and hence cannot itself accommodate the volume decreases in the sealed tensioner 10. Rather, the air pocket 54 compresses in size and presents additional volume availability for the fluid 38 in the low pressure reservoir 48. The air pocket 54 has an uncompressed state (FIG. 2) when the piston 16 is in an extended state and when no volume compensation is called for in the sealed tensioner 10, and the air pocket 54 has a compressed state (FIG. 3) when the piston 16 is in the retracted state and when volume compensation is called for in the sealed tensioner 10.

If gas of the air pocket 54 from the low pressure reservoir 48 inadvertently makes its way to the high pressure chamber 56, it is thought, the functionality of the sealed tensioner 10 could be hampered. Entrance of the gas into the high pressure chamber 56 poses perhaps an increased risk amid shipping and handling, and before installation of the sealed tensioner 10 and when the sealed tensioner 10 could be oriented in a non-installation position. Still, the air pocket 54 could enter the high pressure chamber 56 post-installation and amid operation in certain applications. To preclude the air pocket 54 from entering into the high pressure chamber 56, one or more baffle walls 58 can be located downstream of an entrance 60 of the high pressure chamber 56. The precise design and construction and arrangement of the baffle wall(s) 58 can vary in different embodiments and can be dictated by, among other possible influences, the configuration of the low pressure reservoir 48 and that of the high pressure chamber 56, as well as the intended installation orientation of the sealed tensioner 10 on the larger application component.

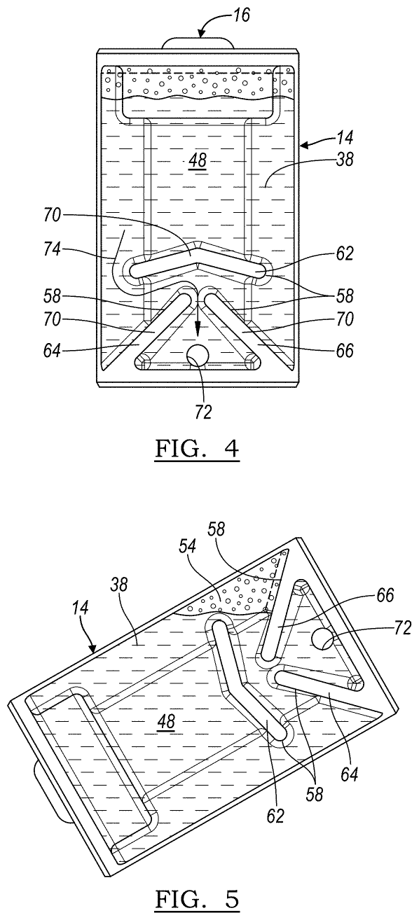

In the embodiment presented by the figures, and referring now to FIGS. 4-6, the baffle wall(s) 58 include a first baffle wall 62, a second baffle wall 64, and a third baffle wall 66. The baffle walls 62, 64, 66 are unitary extensions of the cartridge body 14 and depend from the outer wall 50 of the cartridge body 14, and can be structures die cast or machined or formed some other way into the cartridge body 14. As demonstrated best in FIGS. 2 and 3, each of the first and second and third baffle walls 62, 64, 66 extends fully across the low pressure reservoir 48 and forms a seal 68 at a surface-to-surface interface between the inner wall 32 and a terminal end 70 (FIG. 4) of the respective baffle wall. In this embodiment, and referring to FIG. 4, the first and second and third baffle walls 62, 64, 66 are arranged relative to one another and with respect to an exit 72 of the low pressure reservoir 48 in order to establish an indirect path to the exit 72. The indirect path is denoted in FIG. 4 by an arrowed line 74. Since the air pocket 54 sits atop the fluid 38, the arrangement of the baffle walls 62, 64, 66 and the indirect path 74 presents a barrier to the exit 72 for the air pocket 54, and effectively blocks the air pocket 54 from making its way to the exit 72 and ultimately from making its way to the high pressure chamber 56. The baffle walls 62, 64, 66 do not preclude the fluid 38 from entering and exiting the low pressure reservoir 48, as the fluid 38 can itself follow the indirect path 74.

In this embodiment, the first baffle wall 62 has a downward V-shape and is positioned a short distance above the exit 72, per the orientation presented in FIG. 4. The first baffle wall 62 is spaced from sides of the low pressure reservoir 48 for fluid flow thereby. The second baffle wall 64 is planar and is slanted from a corner of the low pressure reservoir 48 and positioned to one side of the exit 72. Similarly, the third baffle wall 66 is planar and is slanted from an opposite corner of the low pressure reservoir 48 and positioned to an opposite side of the exit 72. The second and third baffle walls 64, 66 are angled toward each other but maintain a gap therebetween at their terminations. Spacings between the first and second and third baffle walls 62, 64, 66 establish the indirect path 74.

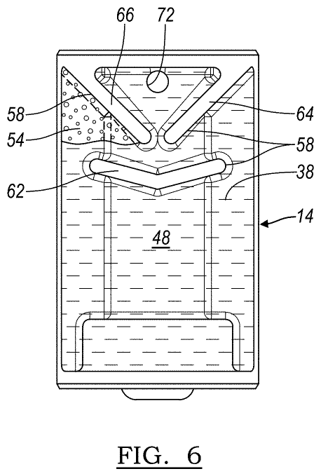

The arrangement of the baffle walls 62, 64, 66 is but a single example meant to preclude the air pocket 54 from entering the high pressure chamber 56 for a sealed tensioner that is to be installed in an upright orientation. The upright orientation of the sealed tensioner 10 is shown in FIGS. 2-4. Still, the arrangement of baffle walls, as well as the quantity of baffle walls, can vary in other examples for sealed tensioners installed upright and for sealed tensioners intended to be installed in other orientations such as tilted and upside-down orientations presented respectively by FIGS. 5 and 6. As an example lacking depiction, for instance, the sealed tensioner 10 could have a single baffle wall located around a large part of the exit's perimeter to block gas, or the sealed tensioner 10 could have a pair of baffle walls located near the exit's perimeter to block gas. In the embodiment of the figures, when the sealed tensioner 10 is brought to a tilted orientation like that of FIG. 5, the air pocket 54 is blocked from access and entrance to the exit 72 by the first and third baffle walls 62, 66. Further, when the sealed tensioner 10 is brought to an upside-down orientation like that of FIG. 6, the air pocket 54 is again blocked from access and entrance to the exit 72 by the first and third baffle walls 62, 66.

The piston 16 is urged to press against a component of the larger tensioner assembly such as an arm which itself is pressed against the belt or chain of the particular configuration. The piston 16 is slidably carried in the bore 34 and can reciprocate inward and outward therein in use between the extended state (FIG. 2) and the retracted state (FIG. 3), as well as increments therebetween. The piston 16 is spring loaded and is biased toward the extended state by way of a spring 76. At an exposed end, the piston 16 has a closed end 78, and at an opposite end the piston 16 has an open end 80. The closed end 78 remains projected out of the cartridge body 14 for abutment with the arm in installation and use. The piston 16 defines a hollow interior 82 spanning between the closed end 78 and the open end 80. A portion of the fluid 38 is present and contained in the interior 82.

The check valve 18 controls flow of the fluid 38 in the sealed tensioner 10 as the piston 16 moves between the extended state and the retracted state, and as the piston 16 moves to incremental states therebetween. The check valve 18 serves as a separation between the low pressure reservoir 48 and the high pressure chamber 56 of the sealed tensioner 10. The fluid 38 in the low pressure reservoir 48 travels to the high pressure chamber 56 when the piston 16 is in the midst of moving toward the extended state. Conversely, the fluid 38 contained in the high pressure chamber 56 is pressurized to a higher pressure as the piston 16 moves toward the retracted state. The check valve 18 is of the one-way valve type and is spring loaded and biased against fluid-flow from the high pressure chamber 56 to the low pressure reservoir 48. The check valve 18 has a body 84, a spring (not shown), and a moveable ball 86. The moveable ball 86 is biased to a seated and closed position by the spring, as shown by FIG. 3. FIG. 2 shows the moveable ball 86 unseated and in its open position. The check valve 18 opens to permit flow of the fluid 38 from the low pressure reservoir 48 to the high pressure chamber 56 when the piston 16 moves toward the extended state. The check valve 18, on the other hand, remains closed to prevent flow of the fluid 38 from the high pressure chamber 56 to the low pressure reservoir 48 when the piston 16 moves toward the retracted state. The check valve 18 is located within the piston's interior 82 and at the open end 80. In other embodiments the check valve 18 could be a disc check valve or some other type.

Turning now to the enlarged view of FIG. 3A, a clearance 88 is incorporated into the design and construction of the cartridge body 14 and piston 16 in order to furnish a damping effect therebetween as the fluid 38 is forced to travel therethrough. The clearance 88 serves as a purposefully designed fluid leak path between the cartridge body 14 and piston 16. The clearance 88 can have a dimension that ranges approximately between 0.025-0.065 millimeters (mm); still, other values are possible for this dimension. If greater purposeful leakage is desired in the sealed tension 10, for instance, metered flow orifices can be lasered into the body 84 of the check valve 18, as but one example for achieving this. The clearance 88 resides at a surface-to-surface confrontation between the cartridge body 14 and piston 16, and is defined between an inner surface 90 of the bore 34 and an outer surface 92 of the piston's wall. The clearance 88 can span around the entire circumferential extent of confrontation between the cartridge body 14 and piston 16. Similarly, the clearance 88 can span the entire longitudinal extent of confrontation between the cartridge body 14 and piston 16. By way of the clearance 88, the fluid 38 can travel from the high pressure chamber 56 to the low pressure reservoir 48 along a return passage 94. And conversely, the fluid 38 can travel from the low pressure reservoir 48 to the high pressure chamber 56 along a supply passage 96. A ball plug 98 seals the passages 94, 96.

When the sealed tensioner 10 is put in use and the piston 16 is moving to the extended state, the check valve 18 opens to permit flow of the fluid 38 from the low pressure reservoir 48 to the high pressure chamber 56. The amount of the fluid 38 in the low pressure reservoir 48 is reduced as a result, and the air pocket 54 grows in size to its uncompressed state. Conversely, when the piston 16 is moving to the retracted state the check valve 18 closes to prevent flow of the fluid 38 from the high pressure chamber 56 to the low pressure reservoir 48 via the check valve 18. The fluid 38 in the high pressure chamber 56 is pressurized and forced to travel through the clearance 88 and to the low pressure reservoir 48. An arrowed line 100 in FIG. 3A demonstrates this forced fluid flow. The forced fluid flow through the clearance 88 introduces a viscous drag and causes a damping effect on the movement of the piston 16 to the retracted state. The movement of the piston 16 is hence inhibited to a degree. The fluid 38 travels through the clearance 88 and then to the low pressure reservoir 48. The amount of the fluid 38 in the low pressure reservoir 48 is increased as a result, and the air pocket 54 shrinks in size to its compressed state.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A sealed tensioner, comprising:
an outer body having a first bore;
a cartridge body received in the first bore, the cartridge body having a second bore;
a piston carried in the second bore and biased to an extended state;
a check valve situated between a low pressure reservoir and a high pressure chamber; and
at least one baffle wall located at the low pressure reservoir, the at least one baffle wall blocking an air pocket residing in the low pressure reservoir from entering the high pressure chamber.

2. The sealed tensioner as set forth in claim 1, wherein the low pressure reservoir is established by confronting surfaces of a fixedly-interfitted outer body and cartridge body, and a seal is formed at least a section of a periphery of the low pressure reservoir via a surface-to-surface interface between the outer body and cartridge body.

3. The sealed tensioner as set forth in claim 1, wherein the piston has an interior, the interior constituting the high pressure chamber.

4. The sealed tensioner as set forth in claim 1, wherein the low pressure reservoir is defined at least in part by an inner wall of the first bore of the outer body and an outer wall of the cartridge body, the inner wall and outer wall confronting each other to at least partly define the low pressure reservoir.

5. The sealed tensioner as set forth in claim 1, wherein the cartridge body has at least one passage for fluid travel between the low pressure reservoir and the high pressure reservoir, the outer body lacking passages for fluid travel.

6. The sealed tensioner as set forth in claim 1, wherein the at least one baffle wall includes a first baffle wall positioned adjacent an exit of the low pressure reservoir and includes a second baffle wall positioned adjacent the exit, the first and second baffle walls spaced from each other and establishing an indirect path at the spacing to the exit of the low pressure reservoir.

7. The sealed tensioner as set forth in claim 1, wherein fluid in the low pressure reservoir compresses the air pocket when the piston is in the midst of moving to a retracted state.

8. The sealed tensioner as set forth in claim 1, further comprising a clearance residing between the cartridge body and the piston, and fluid in the high pressure chamber travels to the low pressure reservoir via the clearance when the piston is in the midst of moving to a retracted state.

9. A sealed tensioner, comprising:
an outer body having a bore with an inner wall;
a cartridge body interfitted in the bore and having an outer wall, a low pressure reservoir established at least in part by a confrontation of the inner wall of the bore and the outer wall of the cartridge body, an air pocket residing in the low pressure reservoir;
a piston carried by the cartridge body, a high pressure chamber established at least in part by an interior of the piston; and
at least one baffle wall extending from the cartridge body and forming a seal with the inner wall of the bore of the outer body, the at least one baffle wall located adjacent an exit of the low pressure reservoir.

10. The sealed tensioner as set forth in claim 9, wherein a second seal is formed in at least a section of a periphery of the low pressure reservoir via a surface-to-surface interface between the inner wall of the bore and the outer wall of the cartridge body.

11. The sealed tensioner as set forth in claim 9, wherein the at least one baffle wall includes a first baffle wall located adjacent the exit of the low pressure reservoir and includes a second baffle wall spaced from the first baffle wall, the first and second baffle walls blocking the air pocket from entering the exit of the low pressure reservoir when the sealed tensioner is oriented to at least one non-installation position.

12. The sealed tensioner as set forth in claim 9, further comprising a clearance and a check valve, the clearance residing between the cartridge body and the piston, the check valve located at an entrance to the high pressure chamber, the check valve preventing fluid-flow thereat from the high pressure chamber to the low pressure reservoir when the piston is in the midst of moving to a retracted state, the prevention of fluid-flow by the check valve forcing fluid-flow from the high pressure chamber to the low pressure reservoir via the clearance.

13. The sealed tensioner as set forth in claim 12, wherein the forced fluid-flow from the high pressure chamber to the low pressure reservoir via the clearance damps the movement of the piston to the retracted state, and the fluid-flow to the low pressure reservoir compresses the air pocket when the piston is in the midst of moving to the retracted state.

14. A sealed tensioner, comprising:
an outer body having a first bore;
a cartridge body received in the first bore, the cartridge body having a second bore, a low pressure reservoir established at least in part by confronting walls of the outer body and the cartridge body, an air pocket residing in the low pressure reservoir;
a piston carried in the second bore and biased to an extended state, the piston having an interior, a high pressure chamber established at least in part by the interior;
a passage defined in the cartridge body for fluid travel between the low pressure reservoir and the high pressure chamber;
a check valve located at an entrance to the high pressure chamber;
a clearance residing between the cartridge body and the piston; and
at least one baffle wall extending from the cartridge body, the at least one baffle wall located downstream of an entrance of the high pressure chamber.

15. The sealed tensioner as set forth in claim 14, wherein a first seal is formed at at least a section of a periphery of the low pressure reservoir via a first surface-to-surface interface between the outer body and cartridge body at the first bore, and a second seal is formed via a second surface-to-surface interface between the at least one baffle wall and the outer body at the first bore.
